(19) United States
(12) Patent Application Publication
(10) Pub. No.: US 2007/0195466 A1
(43) Pub. Date: Aug. 23, 2007

(54) Shock resistance disc drive

(75) Inventor: Hiroshi Suzuki, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/441,180

(22) Filed: May 26, 2006

(30) Foreign Application Priority Data
Feb. 17, 2006 (JP) 2006-041137

(51) Int. Cl. G11B 5/55

(52) U.S. Cl. 360/265.7

(57) ABSTRACT

A carriage supports and drives a suspension that supports a head. The head records information into and reproduces the information from a disc. The carriage includes a stopper that restricts a fluctuation of the disc.

This application claims the right of a foreign priority based on Japanese Patent Application No. 2006-041137, filed on Feb. 17, 2006, which is hereby incorporated by reference herein in its entirety as if fully set forth herein.

### BACKGROUND OF THE INVENTION

The present invention relates generally to a storage, and more particularly to a shock resistance mechanism that restricts a fluctuation of a disc in a disc drive that receives a shock. The present invention is suitable, for example, for a shock resistance mechanism for a hard disc drive (“HDD”) and rotates a disc.

Along with the recent spread of the Internet etc., recording and reproducing opportunities of a large volume of information including audio visual images in various circumstances, and a demand for a portable HDD increases. In stably using the portable HDD in various circumstances, it is necessary to restrict a fluctuation of a disc against the external shocks.

The HDD typically includes a disc as a recording medium, and a head stack assembly (“HSA”) that supports a head and moves the head to a target position on the disc. The HSA includes a carriage (also referred to as an “actuator”, an “E-block” due to its E-shaped section or an “actuator (“AC”) block”), a suspension attached to a support portion of the carriage (referred to as an “arm” hereinafter), and a magnetic head part supported on the suspension. The magnetic head part includes a fine head core (simply referred to as a “head” hereinafter) that records and reproduces a signal, and a slider that supports the head. This is true of an HSA that includes one or more head arms formed by spot-welding a suspension onto a stainless-steel arm plate.

One known shock resistance mechanism is a shock mitigating method for providing anti-shock rubber to an HDD housing frame. Another known shock resistance mechanism is a ramp loading system that holds a slider on a holding member called a ramp when the disc stops and the slider retreats from the disc. The ramp loading system retreats the slider from the disc during a non-operation time, and thus prevents a collision between the disc and the slider during the non-operation time, unlike a contact start stop (“CSS”) system in which the slider contacts the disc when the disc stops and starts rotating. Still another known shock resistance mechanism is a method for increasing a slider's jumping acceleration above the disc and for mitigating the shock acceleration in a collision between the slider and the disc.

Prior art includes, for example, Japanese Patent Application, Publication No. 2002-216445.

However, none of the conventional methods are insufficient to prevent damages of the disc or the slider (or the head) when the disc collides with the slider, arm, and ramp during the operation time and the disc collides with the ramp during the non-operation time.

### BRIEF SUMMARY OF THE INVENTION

Accordingly, the present invention is directed to a carriage, an HSA, and a disc drive having the HSA, which restricts a fluctuation of the disc in the disc drive that receives a shock.

An HSA according to another aspect of the present invention includes a suspension that supports a head that records information into and reproduces the information from a disc, a carriage that supports and drives the suspension, and a stopper that is provided on the carriage, and restricts a fluctuation of the disc. In the HSA, the stopper is provided onto the carriage as a driving part, and restricts a fluctuation of the disc that receives a shock. Since driving of the carriage corresponds to an operation time and a non-operation time of the disc, and a slider's position, i.e., whether it is located above the inner side or outer side of the disc, the fluctuation of the disc that receives a shock can be restricted according to the operational status of the disc or the slider's position.

The stopper, for example, has a U-shaped section that holds an edge of the disc. The U-shaped section sandwiches the disc, and restricts a vertical movement of the disc. The stopper contacts a chamfer or an outer circumferential part of the disc.

The stopper may include a first stopper that contacts the disc that stops rotating. Thereby, the first stopper contacts the disc during the non-operation time and restricts or removes its movement. The first stopper may have an arc shape that sets a rotating axis of the disc to a center. The first stopper concentric to the disc can increase the contact area with the disc, and improve the fluctuation reduction effect.

The stopper may include a second stopper spaced from the disc by a predetermined clearance. This configuration can restrict a fluctuation of the disc during the operation. The predetermined clearance preferably includes a first clearance when the head separates from the disc, and a second clearance when the head is located above the disc, the second clearance being greater than the first clearance. The second clearance that is set greater than the first clearance prevents frequent contacts between the disc and the second stopper, when the head retreats to the ramp, etc. When the disc contacts the second stopper during the operation time, the recording/reproducing action usually stops, and this configuration prevents frequent stops of the recording/reproducing action. The first clearance may be 0.

The predetermined clearance preferably includes a third clearance when the head is located above an inner side of the disc, and a fourth clearance when the head is located above an outer side of the disc, the fourth clearance being greater than the third clearance. This is because a fluctuation of the disc at the outer side is greater than a fluctuation of the disc at the inner side. Therefore, the clearance for the outside which is similar to the clearance of the inner side causes the disc to frequently contact the second stopper when the head is located above the outer side of the disc. In addition, this configuration can make contact the shock resistance value over the whole zone on the disc.

Preferably, the carriage rotates around a shaft, and the second stopper has an arc shape that sets the shaft to a center. A neighborhood near the shaft has a high rigidity, and the shock caused by the contact between the disc and the second stopper is less likely to propagate to the head. When the second stopper is concentric to the shaft, the distance between the second stopper and the disc is maintained constant irrespective of the rotation of the carriage. Therefore, the second stopper can restrict the fluctuation of the disc irrespective of a rotating position of the carriage, i.e., whether the disc rotates or stops or whether the slider is located above the inner part or the outer part on the disc. The arc shape of the second stopper is equal to or greater than an angle at which the carriage can rotate. This configuration can restrict the fluctuation of the disc over the rotating range of the carriage.

The stopper may be formed integrally with the carriage. Thereby, the number of components is fewer than case where the stopper is formed as a separate member. The stopper is made of a material, such as resin, which does not damage the disc when it contacts the disc. Thereby, the disc gets less damaged than case where the stopper is made of a hard material, such as metal.

A disc drive including the above HSA also constitutes one aspect of the present invention.

A carriage according to another aspect of the present invention supports and drives a suspension that supports a head. The head records information into and reproduces the information from a disc. The carriage includes a stopper that restricts a fluctuation of the disc. This carriage exhibits a similar operation to that of the above HSA.

A method for driving a disc drive that includes a suspension that supports a head that records information into and reproduces the information from a disc, a carriage that supports and drives the suspension and moves to a standby position during a non-operation time, and a stopper that is provided on the carriage, and contacts the disc that stops rotating and restricts a fluctuation of the disc includes the steps of driving the carriage before the disc rotates, and stopping rotating the disc before the carriage reaches the standby position. This driving method can eliminate a shock that would otherwise be applied to the stopper and the disc at the operation start time and the operation stop time.

Other objects and further features of the present invention will become readily apparent from the following description of the preferred embodiments with reference to accompanying drawings.

### BRIEF DESCRIPTION OF THE DRAWINGS

FIG. 1 is a plane view of an internal structure of a hard disc drive (“HDD”) according to one embodiment of the present invention.

FIG. 2 is an enlarged perspective view of a magnetic head part in the HDD shown in FIG. 1.

FIG. 3A is a sectional view taken along a line A-A, and FIG. 3B is a plane view of a development of a second stopper shown in FIG. 1.

FIG. 4 is a plane view of a carriage shown in FIG. 1 that has rotated.

FIG. 5A is a schematic plane view of a head stack assembly according to one aspect of the present invention, and FIG. 5B is a schematic plane view of a conventional head stack assembly.

### DETAILED DESCRIPTION OF THE PREFERRED EMBODIMENTS

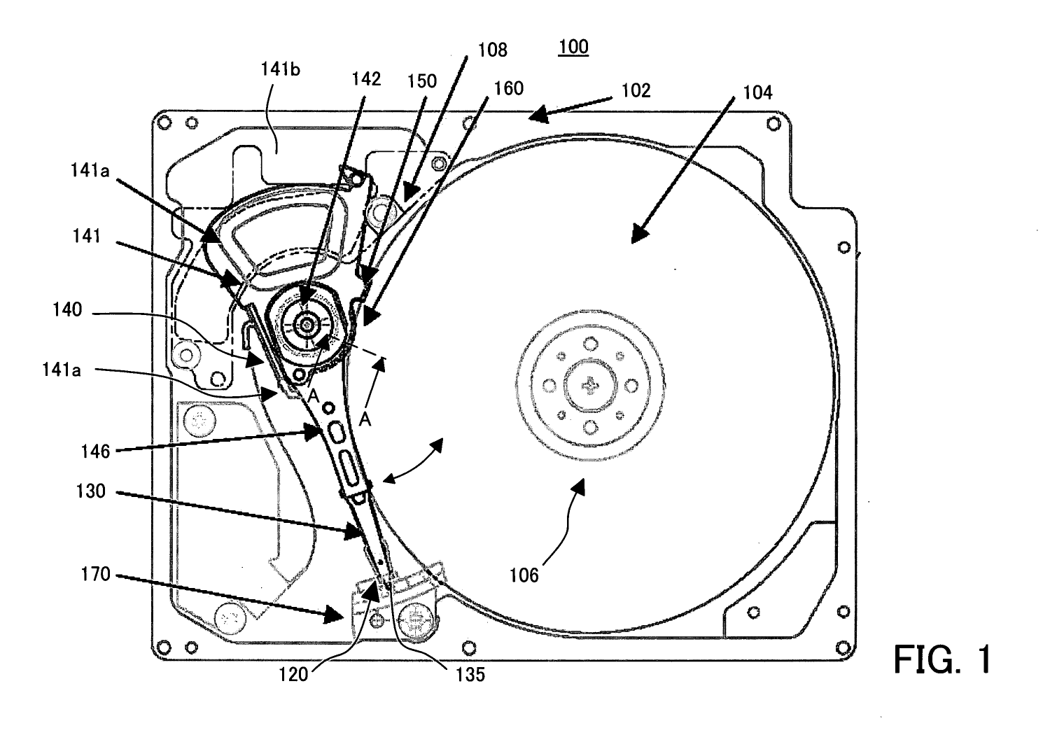

Referring now to the accompanying drawings, a description will be given of a HDD 100 according to one embodiment of the present invention. The HDD 100 includes, as shown in FIG. 1, one or more magnetic discs (simply “disc” hereinafter”) 104 each serving as a recording medium, a spindle motor 106, a stopper 108, a head stack assembly (“HSA”) 110, a shock resistance mechanism, and a ramp 170 in a housing 102. Here, FIG. 1 is a schematic plane view of the internal structure of the HDD 100.

The housing 102 is made, for example, of aluminum die cast base and stainless steel, and has a rectangular parallelepiped shape with which a cover (not shown) that seals the internal space is joined. The magnetic disc 104 of this embodiment has a high surface recording density, such as 100 Gb/in² or greater. The magnetic disc 104 is mounted on a spindle of the spindle motor 106 through a center hole of the magnetic disc 104.

The spindle motor 106 includes, for example, a brushless DC motor (not shown) and a spindle as its rotor part. For instance, two magnetic discs 104 are used in order of the disc, a spacer, the disc and a clamp stacked on the spindle, and fixed by bolts coupled with the spindle. Unlike this embodiment, the magnetic disc 104 may be a disc that has no center hole but a hub, and the spindle rotates the disc via the hub.

The stopper 108 contacts the end of the carriage 140 of the HSA 110, which will be described later, and restricts the rotation of the carriage 140.

The HSA 110 includes a magnetic head part 120, a suspension 130, a carriage 140, and a base plate (not shown).

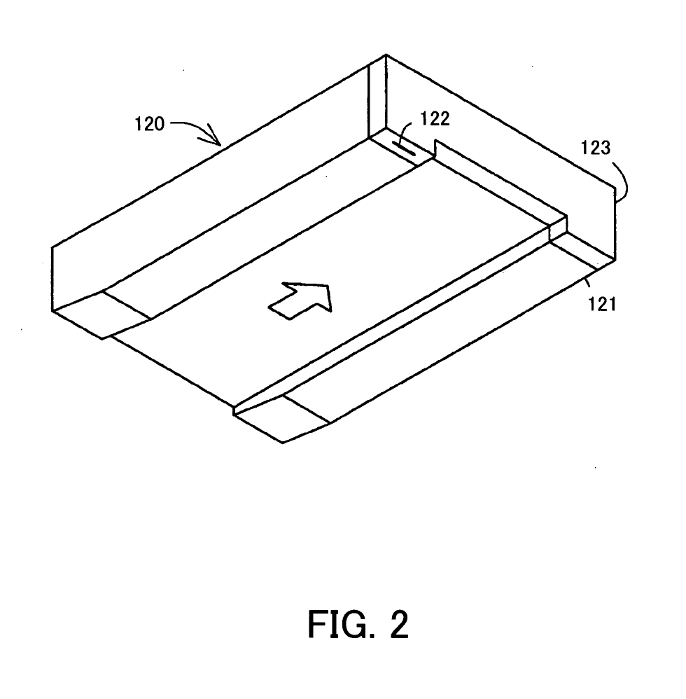

The magnetic head 120 includes, as shown in FIG. 2, a slider 121, and a head device built-in film 123 that is jointed with an air outflow end of the slider 121 and has a reading and recording head 122.

The suspension 130 serves to support the magnetic head part 120 and to apply an elastic force to the magnetic head part 120 against the magnetic disc 104, and is, for example, a stainless-steel Watlas type suspension. The suspension 130 has a flexure (also referred to as a gimbal spring or another name) which cantilevers the magnetic head part 120, and a load beam (also referred to as a load arm or another name) which is connected to the base plate. The load beam has a spring part at its center so as to apply a sufficient compression force in a Z direction. The magnetic head part 120 is designed to softly pitch and roll around a dimple. The suspension 130 also supports a wiring part that is connected to the magnetic head part 120 via a lead etc.

A lift tab 135 is integrated with the top of and made of the same material as the suspension 130. The lift tab 135 slides on the ramp 170 in loading and unloading of the slider 121. The lift tab 135 loads the slider 121 from the ramp 170 to a point above the disc 104 after the disc 104 starts rotating, and unloads the slider 121 from the top above the disc 104 to hold it on the ramp 170 when the disc 104 stops rotating.

The carriage 140 serves to rotate the magnetic head part 120 in arrow directions shown in FIG. 1, and includes a voice coil motor (“VCM”) 141, a shaft 142, a FPC (not shown), and an arm 146. In addition, the carriage 140 of this embodiment is provided with a shock resistance mechanism, as described later.

The VCM 141 has a flat coil 141a between a pair of yokes (not shown). The flat coil 141a opposes to a magnetic circuit 141b that is provided on the housing 102, and the carriage 140 swings around the support shaft 142 in accordance with current values flowing through the flat coil 141a. The magnetic circuit 141b includes, for example, a permanent magnet fixed onto an iron plate fixed in the housing 102, and a movable magnet fixed onto the carriage 140. The shaft 142 is inserted into a hollow cylinder in the carriage 140, and extends perpendicular to the paper surface of FIG. 1 in the housing 102. The FPC (not shown) provides the wiring part with a control signal, a signal to be recorded in the disc 104, and the power, and receives a signal reproduced from the disc 104.

The arm 146 is configured to rotate or swing around the shaft 142, and the suspension 130 is attached to the arm 146.

The shock resistance mechanism is provided onto the carriage 140, and implemented as a stopper that restricts a fluctuation of the disc 104 that receives a shock. The stopper in this embodiment contacts the disc 104 that receives a shock and restricts its fluctuation or limits its displacement. Driving of the carriage 140 corresponds to the operational status of the disc 104, i.e., whether the disc 104 is in an operation time and a non-operation time, and a location of the slider 121, i.e., whether the slider 121 is located above the inner part or outer part of the disc 104. Therefore, a fluctuation of the disc 104 that received a shock can be restricted according to the status of the disc 104 and the location of the slider 121.

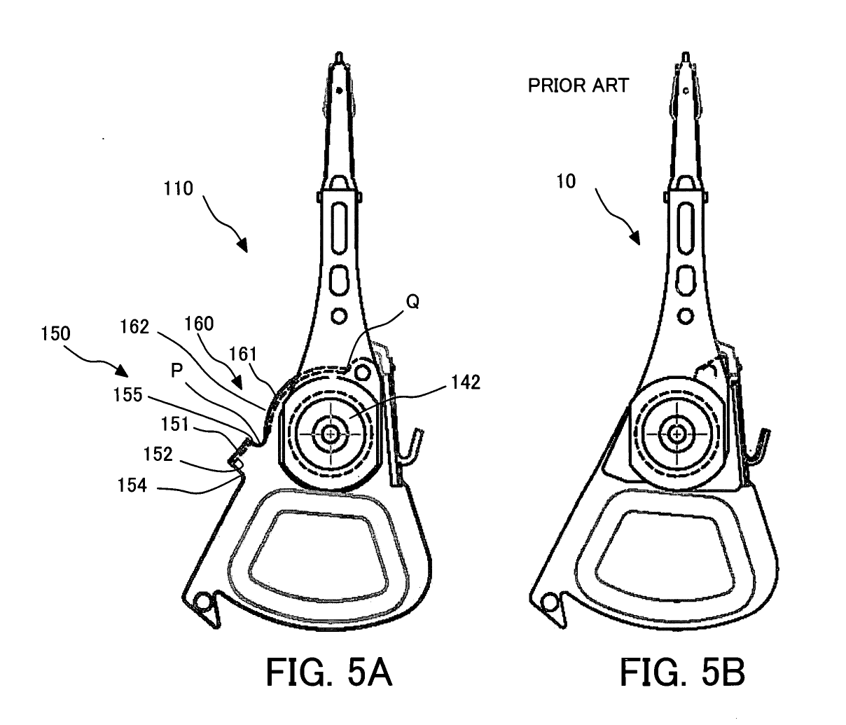

The shock resistance mechanism of this embodiment includes a first stopper 150, and a second stopper 160. FIG. 5A is a plane view of the HSA 110 showing details of the first and second stoppers 150 and 160. FIG. 5B is a plane view of the conventional HSA 10. The HSA 110 of this embodiment is different from the conventional HSA 10 in having the first and second stoppers 150 and 160.

The first stopper 150 contacts the disc 104 that stops rotating, at an edge (a side surface of the disc 104 and chamfered part at interfaces between the side surface and the front and rear surfaces of the disc 104) of the disc 104 during the non-operation time, and restricts its fluctuation or limits its displacement.

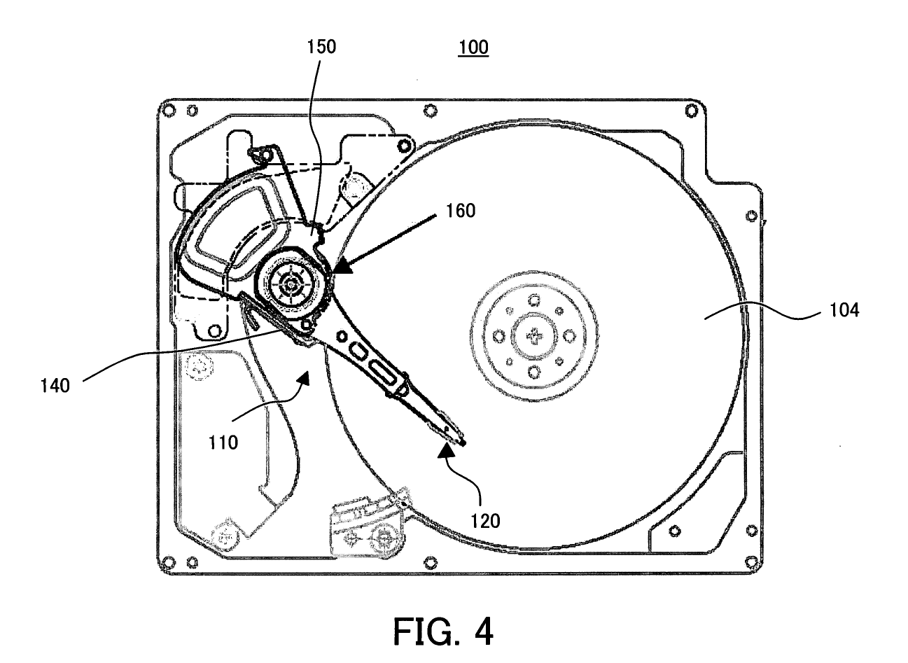

The first stopper 150 contacts the disc 104, as shown in FIG. 1, when the lift tab 135 is held at a predetermined position of the ramp 170. The “predetermined position of the ramp 170” in this embodiment means a standby position at which the lift tab 135 is held at the non-operation time. In addition, the first stopper 150 is spaced from the disc 104, as shown in FIG. 4, as the slider 121 moves from the predetermined position on the ramp 170 toward the disc 104.

The first stopper 150 is provided onto the carriage 140 opposite to the disc 104 or the suspension 130 with respect to the shaft 142 and at a side of the carriage 140 near the disc 104. Thereby, the first stopper 150 can approach to the disc 104 when the arm 146 or the suspension 130 retreats from the disc 104.

The first stopper 150 is integrally formed with the carriage 142. Thereby, the number of components is fewer than case where the first stopper 150 is formed as a separate member. The first stopper 150 is made of a material, such as resin, which does not damage the disc 104 when it contacts the disc 104. Thereby, the disc 104 gets less damaged than case where the first stopper 150 is made of a hard material, such as metal.

The first stopper 150 has an arc shape that sets the rotating axis of the disc 104 to a center. Since the first stopper 150 is formed concentric to the disc 104, the contact area with the disc 104 is maximized for stable fixations. The center angle of the arc is not specifically limited. As the arc extends, the fixing length for the disc 104 elongates, and the fixation of the disc becomes more stable. However, the excessively long arc collides with the stopper 108, and may extend beyond the shaft 142 toward the suspension 130 side and collide with the disc 104. Therefore, the length of the arc has an upper limit. This embodiment sets the center angle of the arc between about 3° and about 5°.

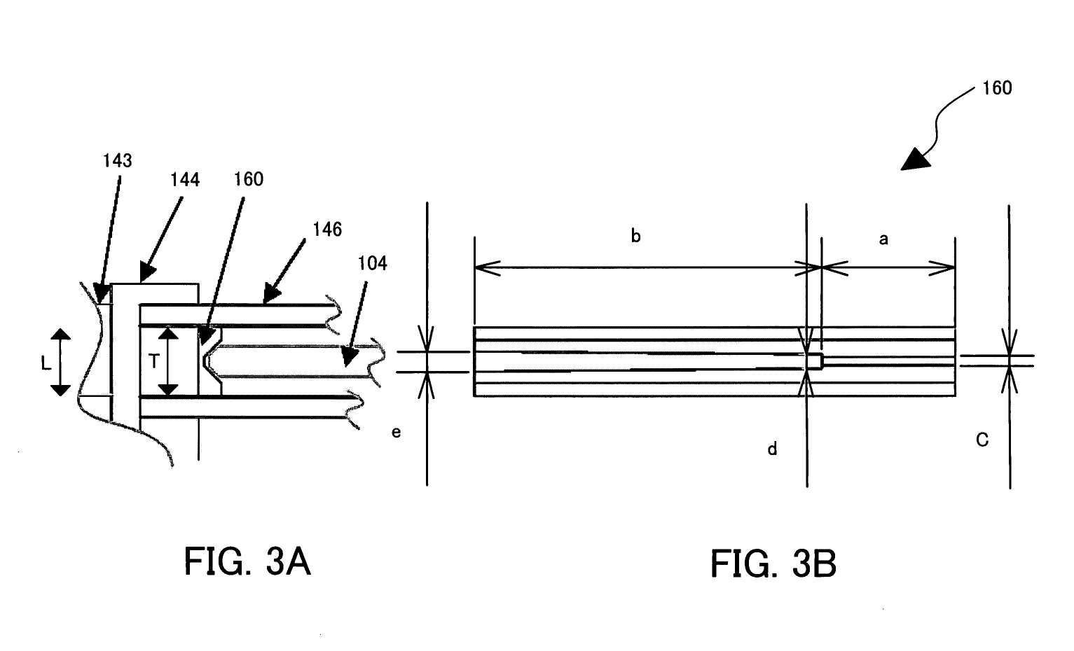

Similar to the second stopper 160 shown in FIG. 3A, which will be described later, the first stopper 150 has a U-shaped section to hold the edge of the disc 104. The U-shaped section sandwiches the edge of the disc 104, and restricts the fluctuation of the disc 104 in a direction perpendicular to the paper plane shown in FIG. 1.

As shown in FIG. 5A, the first stopper includes arcs 151 and 152 having a common rotational center as the center of the disc 104, a side 154 at the VCM side, and a side 155 at the suspension side. A distance from the rotating center of the disc 104 to the arc 151 is slightly smaller than the radius of the disc 104, and thus slightly projects above the disc 104. Assume the arc 151 indicated by a solid line is extended by a predetermined thickness in a direction perpendicular to the paper plane shown in FIG. 5A. The arc 152 indicated by a dotted line is formed by scooping, along the circumferential direction of the arc 151, a center of the extended surface in the thickness direction so that the arc 152 fits the disc 104. Therefore, the disc 104 projects between the arcs 151 and 152 when viewed from the top, and the first stopper 150 fixes the disc 104 in the direction perpendicular to the paper plane shown in FIG. 1. Shapes of the sides 154 and 155 are not limited. This embodiment connects the side 155 smoothly to the surface of the second stopper 160.

As long as the first stopper 150 contacts and stably holds the disc 104, the shape of the first stopper 150 is not limited. For example, this embodiment allows the first stopper 150 to contact the disc 104 on the entire plane including the arcs 151 and 152 along the longitudinal direction (or circumferential direction of the disc 104 around the rotating center), the present invention allows the first stopper 150 to intermittently contact the disc 104 over its opposing surface.

The second stopper 160 is arranged apart from the disc 104 by a predetermined clearance, and restricts the displacement of the disc 104 whether the disc 104 is in the operation state or in the non-operation state.

FIG. 3A is a sectional view of FIG. 1 taken along a line A-A. FIG. 4B is a plane view of the developed second stopper 160. As shown in FIG. 1, the second stopper 160 is provided like an arc shape that sets the rotating center of the shaft 142 to the center.

As shown in FIG. 3A, a bearing sleeve 143 and a bearing 144 are provided onto and around the shaft 142, maintaining the rigidity. Therefore, when the disc 104 contacts the second stopper 160 during the operation time, the shock is less likely to propagate to the magnetic head part 120. More specifically, the shock applied near the shaft 142 propagates to the HDD 100 entirely through the housing 102.

When the contour of the second stopper 160 is concentric to the rotating center of the shaft 142, the distance between the second stopper 160 and the disc 104 can be maintained constant irrespective of the rotating position of the carriage 140. When the contour of the second stopper 160 is not concentric to the rotating center of the shaft 142, the distance with the disc 104 changes as the carriage 140 rotates, like the first stopper 150 shown in FIGS. 1, 3A and 3B. In this case, the carriage can restrict a fluctuation of the disc 104 only when it is located at a predetermined position. On the other hand, the second stopper 160 can restrict the fluctuation of the disc whether the slider 121 is located above the inner side or outer side of the disc 104, or whether the disc 104 rotates or stop rotating.

The center angle of the arc of the second stopper 160 is preferably equal to or slightly larger than the rotating angle of the carriage 140, in order to enable the second stopper 160 to restrict the fluctuation of the disc 104 over a rotating range of the carriage 140.

The second stopper 160 is formed integrally with the carriage 140. Thereby, the number of components is fewer than case where the second stopper 160 is formed as a separate member. The second stopper 160 is made of a material, such as resin, which does not damage the disc 104 when it contacts the disc 104. Thereby, the disc 104 gets less damaged than case where the second stopper 160 is made of a hard material, such as metal.

The second stopper 160 has a U-shaped section to hold the edge of the disc 104. The U-shaped section sandwiches the edge of the disc 104, and restricts the vertical fluctuation of the disc 104. The second stopper 150 has a shape that scoops the side center of the hollow cylinder.

Arcs 161 and 162 each setting a center as a rotating center of the carriage 140 define the contour of the second stopper 160, as shown in FIG. 5A. The arc 161 slightly projects above the disc 104, and extends from a point P to a point Q. As described above, the center angle of the arc 161 corresponds to a rotating range of the carriage 140. Assume the arc 161 indicated by a solid line is extended by a predetermined thickness in a direction perpendicular to the paper plane shown in FIG. 5A. The arc 162 indicated by a dotted line is formed by scooping, along the circumferential direction of the arc 161, a center of the extended surface in the thickness direction so that the arc 162 fits the disc 104. The direction perpendicular to the paper plane in FIG. 5A is an L direction in FIG. 3A, and the predetermined thickness is T. Therefore, the disc 104 projects between the arcs 161 and 162 when viewed from the top, and the second stopper 160 restricts the displacement of the disc 104 in the L direction.

Referring now to FIG. 3B, a description will be given of the predetermined clearance in the L direction of the second stopper 160. In FIG. 3B, an area “a” corresponds to an area in which the slider 121 retreats from the disc 104, and in which the lift tab 135 moves to the predetermined position on the ramp 170. An area “b” corresponds to an area in which the slider 121 is located above the disc 104.

At the right end of the area “a,” the lift tab 135 is held on the predetermined position of the ramp 170. In the area “a,” a clearance between the second stopper 160 and the disc 104 is “c,” which is smaller than the clearance “d” in the area “b.” When the disc 104 contacts the second stopper 160 during the operation time, the recording/reproducing action usually stops. Therefore, the clearance “d” greater than the clearance “c” prevents frequent stops of the recording/reproducing action. In FIG. 3B, the clearance “c” in the area “a” is constant but not 0. However, it may gradually decrease from the left to right in the area “a” in FIG. 3B in an alternate embodiment. The clearance at the right end of the area “a” may be 0, because the disc 104 stops at the right end of the area “a” and the second stopper 160 may contact the disc 104 similar to the first stopper 150. On the other hand, the clearance of the left end in the area “a” is not set to 0, because the disc 104 is still rotating and the clearance of 0 would result in applications of large shocks to the disc 104 and the carriage 104.

A clearance “e” at the left end of the area “b” corresponds to a clearance when the slider 121 is located at the innermost side above the disc 104, and a clearance “d” at the right end of the area “b” corresponds to a clearance when the slider 121 is located at the outermost side above the disc 104.

This embodiment sets the clearance “e” smaller than clearance “d” (i.e., d>e), because the fluctuation of the outer side of the disc 104 is greater than the fluctuation of the inner side of the disc 104. Therefore, when the clearance “d” at the outer side is made similar to the clearance “e” at the inner side, the disc 104 frequently contacts the second stopper 160 and the recording/reproducing action frequently stops when the slider is located above the outer side of the disc 104. In addition, this configuration can set the shock resistance value constant over the whole zone of the disc 104.

A shape of the second stopper 160 is not limited as long as it contacts the disc 104 that receives a shock and restricts the fluctuation of the disc 104.

The ramp 170 is provided near the outermost circumference the disc 104, and partially projects above the disc 104. The ramp 170 is fixed onto the bottom surface of the housing 102 via a screw, etc., and guides, holds, and slidably contacts the lift tab 135.

The HDD 100 includes, as a control system (not shown), a controller, an interface, a hard disc controller (referred to as “HDC” hereinafter), a write modulator, a read demodulator, and a head IC. The controller covers any processor such as a CPU and MPU irrespective of its name, and controls each part in the control system. The interface connects the HDD 100 to an external apparatus, such as a personal computer (“PC” hereinafter) as a host. The HDC sends to the controller data that has been demodulated by the read demodulator, sends data to the write modulator. The controller or HDC provide servo control over the spindle motor 106 and (a motor in) the carriage 140. The write modulator modulates data and supplies data to the head IC, which data has been supplied, for example, from the host through the interface and is to be written down onto the disc 104, for example, by the inductive head. The read demodulator demodulates data into an original signal by sampling data read from the disc 104, for example, by the MR head device. The write modulator and read demodulator may be recognized as a single integrated signal processor. The head IC serves as a preamplifier.

In operation of the HDD 100, the lift tab 135 is initially held on the predetermined position of the ramp 170 as shown in FIG. 1. In this state, the first stopper 150 contacts and fixes the disc 104. In addition, the second stopper 160 restricts a fluctuation of the disc 104 through the narrow clearance “c” in the area “a.” Since the first and second stoppers 150 and 160 restrict the fluctuations of the disc 104, the disc 104 even received a shock is protected from a collision with the projection portion of the ramp 170. Therefore, this embodiment can prevent a deformation and a damage of the disc 104.

Next, the controller (not shown) controls the carriage 140 and rotates the arm 146 around the shaft 142, in response to the host instructions. In addition, the controller drives the spindle motor 106, and rotates the disc 104. In this case, the controller should rotate the carriage 140 first. Thereby, the first stopper 150 separates from the disc 104, and the disc 104 can be rotated. When the controller rotates the disc 104 first, a shock occurs between the first stopper 150 and the disc 104 because the disc 104 is rotated while the first stopper 150 contacts the disc 104.

As the carriage 140 rotates, the lift tab 135 moves on the ramp 170. Next, the lift tab 135 moves above the disc 104, and the head 122 seeks for the target track on the disc 104.

The airflow associated with the rotations of the disc 104 occurs between the disc 104 and slider 121, forming a minute air film and thus generating the buoyancy that enables the slider 121 to float over the disc surface. On the other hand, the suspension 130 applies an elastic compression force to the slider 121 in a direction opposing to the buoyancy of the slider 121. The balance between the buoyancy and the elastic force spaces the magnetic head part 120 from the disc 104 by a constant distance.

In writing, the controller (not shown) receives data from the host through the interface, selects the inductive head device, and sends data to the write modulator through the HDC. In response, the write modulator modulates the data, and sends the modulated data to the head IC. The head IC amplifies the modulated data, and then supplies the data as write current to the inductive head device. Thereby, the inductive head device writes down the data onto the target track.

In reading, an output from a head device that changes according to a signal current is amplified by the head IC and supplied to the read demodulator to become an original signal. The demodulated signal is sent to the host (not shown) via the HDC, controller, and interface.

According to this embodiment, when the slider is located above the outer side of the disc 104, the second stopper 160 restricts the fluctuation of the disc 104 by a clearance “d” in the area “b,” and when the slider is located above the inner side of the disc 104, the second stopper 160 restricts the fluctuation of the disc 104 by a clearance “e” in the area “b.” This configuration will mitigate a shock when the disc 104 collides with the slider 121 during the operation time, and protects one or both of them from damages. This configuration restricts the fluctuation of the disc 104 to some extent while restraining the frequent interruptions of the recording/reproducing action due to the contact between the disc 104 and the second stopper 160.

When the reading/recording action ends, the controller controls the carriage 140 and rotates the arm 146 from the inner side to the outer side of the disc 104 around the shaft 142. Thereby, the lift tab 135 is unloaded from the disc 104. Thereafter, the lift tab 135 is held on the ramp 107.

The controller controls the spindle motor 106, and stops driving the disc 104. In this case, before the lift tab 135 reaches the predetermined position on the ramp 170, the controller needs to control the spindle motor 106 and halts the rotation of the disc 104. This is because when the lift tab 135 reaches the predetermined position on the ramp 170, the first stopper 150 contacts the disc 104, and both might get damaged. The instant configuration solves this problem.

Further, the present invention is not limited to these preferred embodiments, and various modifications and variations may be made without departing from the spirit and scope of the present invention.

What is claimed is:

1. A carriage that supports and drives a suspension that supports a head, the head recording information into and reproducing the information from a disc, said carriage comprising a stopper that restricts a fluctuation of the disc.

2. A head stack assembly comprising:
a suspension that supports a head that records information into and reproduces the information from a disc;
a carriage that supports and drives said suspension; and
a stopper that is provided on said carriage, and restricts a fluctuation of the disc.

3. A head stack assembly according to claim 2, wherein said stopper has a U-shaped section that holds an edge of the disc.

4. A head stack assembly according to claim 2, wherein said stopper includes a first stopper that contacts the disc that stops rotating.

5. A head stack assembly according to claim 4, wherein the first stopper contacts a chamfer or an outer circumferential part of the disc.

6. A head stack assembly according to claim 4, wherein a contact surface of the first stopper is set to a chamfer or an outer circumferential side of a data zone of the disc.

7. A head stack assembly according to claim 4, wherein the first stopper has an arc shape that sets a rotating axis of the disc to a center.

8. A head stack assembly according to claim 2, wherein said stopper includes a second stopper spaced from the disc by a predetermined clearance.

9. A head stack assembly according to claim 8, wherein the predetermined clearance includes a first clearance when the head separates from the disc, and a second clearance when the head is located above the disc, the second clearance being greater than the first clearance.

10. A head stack assembly according to claim 8, wherein the predetermined clearance includes a third clearance when the head is located above an inner side of the disc, and a fourth clearance when the head is located above an outer side of the disc, the fourth clearance being greater than the third clearance.

11. A head stack assembly according to claim 8, wherein said carriage rotates around a shaft, and the second stopper has an arc shape that sets the shaft to a center.

12. A head stack assembly according to claim 11, wherein the arc shape of the second stopper has substantially the same central angle as an angle at which said carriage can rotate.

13. A head stack assembly according to claim 2, wherein said stopper is formed integrally with said carriage.

14. A head stack assembly according to claim 2, wherein said stopper is made of resin.

15. A disc drive comprising a head stack assembly according to claim 2.

16. A method for driving a disc drive that includes a suspension that supports a head that records information into and reproduces the information from a disc, a carriage that supports and drives said suspension and moves to a standby position during a non-operation time, and a stopper that is provided on the carriage, and contacts the disc that stops rotating and restricts a fluctuation of the disc, said method comprising the steps of:
driving the carriage before the disc rotates; and
stopping rotating the disc before the carriage reaches the standby position.
